(19) United States
(12) Patent Application Publication
(10) Pub. No.: US 2024/0191907 A1
(43) Pub. Date: Jun. 13, 2024

(54) AIR PURIFICATION DEVICE

(71) Applicant: Yung-Jen CHEN, Kaohsiung City (TW)

(72) Inventor: Yung-Jen CHEN, Kaohsiung City (TW)

(21) Appl. No.: 18/502,014

(22) Filed: Nov. 5, 2023

(30) Foreign Application Priority Data
Dec. 13, 2022 (TW) 111147879

(51) Int. Cl. F24F 13/20; A62B 18/02; F24F 8/108

(52) U.S. Cl. CPC F24F 13/20; A62B 18/02; F24F 8/108

(57) ABSTRACT

An air purification device includes a casing with an air inlet portion, an air outlet portion, and an air-guiding portion coupled in fluid communication between the air inlet portion and the air outlet portion; at least one filtering mask detachably disposed in a space defined by the casing, wherein the filtering mask has a first filtration member and a second filtration member movably combined; wherein in a first configuration mode, the air inlet portion, the first filtration member, and the air-guiding portion are in a first fluid-communication state, and the second filtration member is in a fluid-closed state; in a second configuration mode, the first filtration member and the casing are in a mutually separated state, and the first filtration member and the second filtration member are in a second fluid-communication state; and a fan disposed inside the casing.

### CROSS REFERENCE TO RELATED APPLICATIONS

This application claims the priority of Taiwan Patent Applications No. 111147879, titled as “AIR PURIFICATION DEVICE EQUIPPED WITH FILTERING MASK”, filed on Dec. 13, 2022, the disclosures of which are incorporated herein by reference.

### FIELD OF THE INVENTION

The present disclosure relates to the technical field of air purifiers, and specifically to an air purification device.

### BACKGROUND OF THE INVENTION

According to statistical results, the fatal reasons for building fires mainly include inhalation of poisonous gas resulting in suffocation and coma.

It is known that smoke-proof filtering masks and air purification devices are products with different purposes and cannot be universally used because the filtering methods and materials of the smoke-proof filtering masks and the air purification device are different.

It is common to have an air purification device in the family space. However, it is rare for the family space to be provided with a smoke-proof filtering mask required for the fire escape. The reason for the above is that the smoke-proof filtering mask needs to focus on a solid smoke-filtering function. In contrast, the air purification device usually focuses on dust removal and/or deodorization functions. Due to different functional orientations, it is difficult for the filter material with a smoke-proof function and the filter material required by the air purification device to be universally used. Although there have been some products with single or integrated functions in the past, they still need to be improved.

Given the above, it is necessary to provide a technical solution different from the past to solve the problems in the prior art.

### SUMMARY OF THE INVENTION

An object of the present disclosure is to provide an air purification device applicable to different scenarios of ventilation at a fixed position and being worn for filtering air.

To achieve the purpose mentioned above, one aspect of the present disclosure provides an air purification device, including: a casing provided with an air inlet portion, an air outlet portion, and an air-guiding portion, wherein the air-guiding portion is coupled in fluid communication between the air inlet portion and the air outlet portion; at least one filtering mask detachably arranged in a space defined by the casing, wherein the filtering mask has a first filtration member and a second filtration member movably combined with the first filtration member; in a first configuration mode, the air inlet portion, the first filtration member, and the air-guiding portion are configured to be in a first fluid-communication state, and the second filtration member is configured to be in a fluid-closed state; in a second configuration mode, the first filtration member and the casing are configured to be a mutually separated state, and the first filtration member and the second filtration member are configured to be in a second fluid-communication state; and a fan disposed in the casing.

In an embodiment of the present disclosure, the casing has a shell assembly and a circulation assembly, the shell assembly surrounds the circulation assembly, and the at least one filtering mask is coupled in fluid communication between the shell assembly and the circulation assembly.

In an embodiment of the present disclosure, the circulation assembly includes a first circulation part and a second circulation part, the first circulation part is coupled in fluid communication with the second circulation part to form the air-guiding portion, and the at least one filtering mask is coupled in fluid communication between the first circulation part and the air inlet portion.

In an embodiment of the present disclosure, the first circulation part is provided with a first supporting portion, and in the first configuration mode, the first filtration member and the second filtration member are configured to be held apart from each other by sandwiching the first supporting portion.

In an embodiment of the present disclosure, the second circulation part is provided with a second supporting portion, and in the first configuration mode, the first filtration member and the second filtration member are configured to be held apart from each other by sandwiching the second supporting portion.

In an embodiment of the present disclosure, the filtering mask is provided with a supporting member detachably disposed between the first filtration member and the second filtration member, and in the first configuration mode, the first filtration member and the second filtration member are configured to be held apart from each other by sandwiching the supporting member.

In an embodiment of the present disclosure, the first circulation part is defined with at least one first ventilation portion and at least one second ventilation portion, the second circulation part is defined with at least one third ventilation portion and at least one fourth ventilation portion, the at least one filtering mask is coupled in fluid communication between the at least one first ventilation portion and the air inlet portion, the at least one second ventilation portion is coupled in fluid communication with the at least one third ventilation portion, and the at least one fourth ventilation portion is coupled in fluid communication with the air outlet portion.

In an embodiment of the present disclosure, the second circulation part has at least one conduit, and the conduit is coupled in fluid communication with the third ventilation portion and the fourth ventilation portion.

In an embodiment of the present disclosure, the first circulation part is defined with at least one accommodating recess, the at least one accommodating recess is provided with at least one convex part, and the at least one filtering mask is defined with at least one groove that is configured to be slidably engaged with the convex part to cause the at least one filtering mask to be detachably disposed in the at least one accommodating recess.

In an embodiment of the present disclosure, the shell assembly includes a bottom shell, a top shell, and a plurality of side shells, and the plurality of side shells are combined between the bottom shell and the top shell, the at least one filtering mask is disposed between the plurality of side shells and the circulation assembly, and at least one of the plurality of side shells is movably combined with the bottom shell and the top shell.

In an embodiment of the present disclosure, the plurality of side shells include a first side shell and at least one second side shell, and the first side shell is securely combined with the bottom shell between the bottom shell and the top shell, the at least one second side shell is movably combined between the bottom shell and the top shell.

In an embodiment of the present disclosure, the at least one second side shell is pivotably combined between the bottom shell and the top shell to cover or expose the at least one filtering mask.

In an embodiment of the present disclosure, the first side shell is provided with a holding portion that is formed into a slot.

In an embodiment of the present disclosure, the second side shell is provided with a side-opening portion that is formed into an edge-notch.

In an embodiment of the present disclosure, the air inlet portion has a plurality of first groups of through holes circumferentially disposed on the bottom shell.

In an embodiment of the present disclosure, the air outlet portion has a plurality of second groups of through holes disposed on the top shell in a coplanar manner.

In an embodiment of the present disclosure, the top shell is defined with a recess portion, and an inner peripheral wall of the recess portion has a strip-shaped through hole.

In an embodiment of the present disclosure, the first filtration member and the second filtration member are movably combined in a reciprocating manner along an axial direction.

In the air purification device of embodiments of the present disclosure, the at least one filtering mask is detachably arranged in a space defined by the casing, wherein the filtering mask has a first filtration member and a second filtration member movably combined with the first filtration member; in a first configuration mode, the air inlet portion, the first filtration member, and the air-guiding portion are configured to be in fluid communication, and the second filtration member is configured to be fluid-closed; in a second configuration mode, the first filtration member and the casing are configured to be mutually separated, and the first filtration member and the second filtration member are configured to be in fluid communication. It makes the air purification device integrate the function of the filtering mask in case of need.

### BRIEF DESCRIPTION OF THE DRAWINGS

FIG. 1 is a schematic diagram showing a combined perspective view illustrating an air purification device equipped with a filtering mask that can be applied in an embodiment of the present disclosure.

FIG. 2 is a schematic diagram showing an exploded view illustrating an air purification device equipped with a filtering mask that can be applied in an embodiment of the present disclosure.

FIG. 3 is a schematic diagram illustrating an air purification device equipped with a filtering mask in an indoor environment that can be applied in an embodiment of the present disclosure.

FIG. 4 is a schematic diagram illustrating airflow in a cross-sectional view taken along lines A-A in FIG. 3 showing the air purification device equipped with the filtering mask.

FIG. 5 is a schematic diagram illustrating an air purification device equipped with a filtering mask in a smoky environment that can be applied in an embodiment of the present disclosure.

FIG. 6 is a schematic diagram illustrating airflow regarding the air purification device equipped with the filtering mask shown in FIG. 5.

FIG. 7 is a schematic diagram illustrating an exploded view illustrating an air purification device equipped with a filtering mask that can be applied in another embodiment of the present disclosure.

### THE DETAILED DESCRIPTION OF PREFERRED EMBODIMENTS

To make the above and other objects, features, and advantages of the present disclosure more comprehensible, preferred embodiments will be exemplified below in detail, together with attached drawings. Furthermore, directional terms mentioned in the present disclosure, such as upper, lower, top, bottom, front, rear, left, right, inner, outer, side, surrounding, central, horizontal, lateral, vertical, longitudinal, axial, radial, uppermost layer or lowermost layer, which only refer to the direction of drawings. Therefore, the directional terms configured above are for illustration and understanding of the present disclosure and are not intended to limit the present disclosure. It should be understood that the terms first and second are used for descriptive purposes only and cannot be interpreted as indicating or implying relative importance or implicitly indicating the quantity of indicated technical features. Thus, a feature defined as first or second may explicitly or implicitly include one or more of said features. In the description of the present disclosure, the meaning of at least one includes one and more than one unless otherwise explicitly defined.

It should be understood that herein, “coupled in fluid communication” means that two members have a structure that can be coupled to each other and allow fluid (such as gas or liquid) to communicate with each other. For example, openings of two hollow members can be combined or approach each other, such that fluid can be guided to flow inside the two hollow members; “fluid-communication state” means that two members can be coupled to each other to present a state in which fluid (such as gas or liquid) can communicate with each other; “fluid-closed state” means that a structure between two members makes fluid (such as gas or liquid) closed to present a state that cannot communicate with each other; “mutually separated state” means a state in which two members are separated and away from each other.

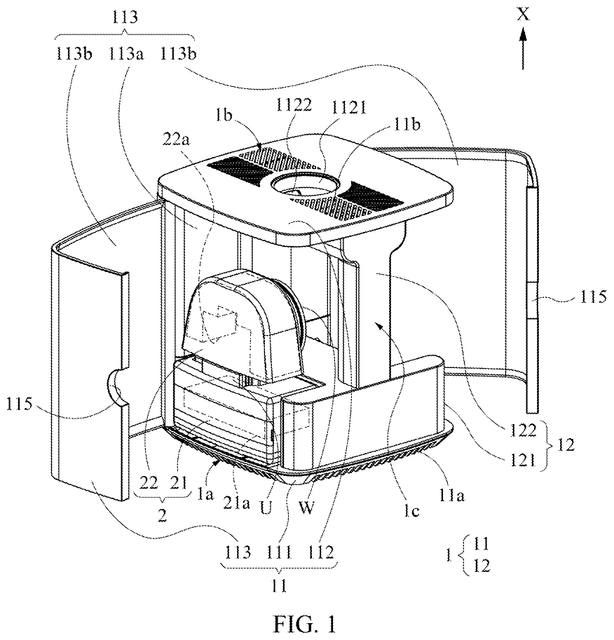

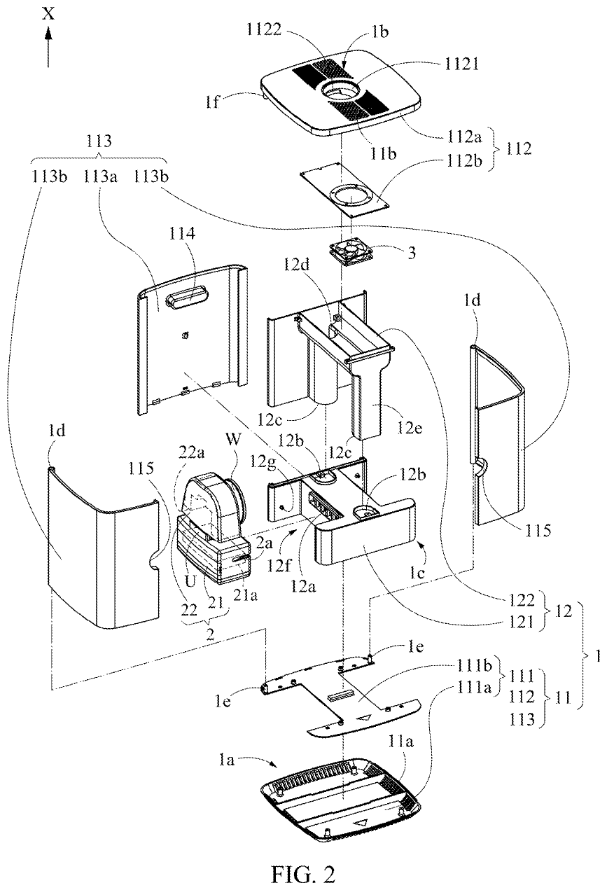

Please refer to FIGS. 1 and 2, one aspect of the present disclosure provides an air purification device, which may include a casing 1, at least one filtering mask 2, and a fan 3. The casing 1 can be used to install the filtering mask 2 and the fan 3. For example, the filtering mask 2 is detachably arranged in a space defined by the casing 1. The fan 3 (such as an axial-flow fan and a blower fan) can be disposed inside the casing 1, e.g., the fan 3 is provided inside a part of an airflow path formed in the casing 1, such as the fan being located at a position around an air inlet or an air outlet portion, or located at a position between the air inlet portion and the air outlet portion, for assisting in generating airflow. Examples illustrating the implementation of the above embodiment of the air purification device of the present disclosure are provided as follows. Still, they are not limited to the description here.

It should be understood that the casing 1 can also be provided with a control part (not shown in the figure) for controlling the fan 3. For example, the control part includes a microcontroller and a man-machine interface. The control part can also be electrically connected to other electrical components, such as power sources (such as wires or batteries) and communication units (such as wireless communication transceivers), for controlling operation modes of the air purification device, such as start, stop, and air volume. Still, they are not limited to the description here.

As an example, as shown in FIGS. 1 and 2, for simplifying the description, the at least one filtering mask 2 is illustrated as having a filtering mask 2 is taken as an example. For example, the casing 1 can be provided with two filtering masks 2, but only one filtering mask 2 equipped is shown, which is not limited to the description here. The relevant description is also applicable to providing more filtering masks 2. For example, a structure of the casing 1 can be adaptively adjusted to accommodate more filtering masks 2.

For example, as shown in FIGS. 1 and 2, the casing 1 can be made of plastic or metal materials. For example, the casing 1 is provided with an air inlet portion 1a, an air outlet portion 1b, and an air-guiding portion 1c. The air-guiding portion 1c is coupled in fluid communication between the air inlet portion 1a and the air outlet portion 1b for assisting in forming an airflow path.

Optionally, in one embodiment, as shown in FIGS. 1 and 2, the casing 1 has a shell assembly 11 and a circulation assembly 12. The shell assembly 11 surrounds the circulation assembly 12. The at least one filtering mask 2 is coupled in fluid communication between the shell assembly 11 and the circulation component 12. For example, the filtering mask 2 is located in the airflow path for providing an air filtering function.

Optionally, in one embodiment, as shown in FIGS. 1 and 2, the shell assembly 11 includes a bottom shell 111, a top shell 112, and a plurality of side shells 113, the plurality of side shells 113 are combined between the bottom shell 111 and the top shell 112. The at least one filtering mask 2 is arranged between the plurality of side shells 113 and the circulation assembly 12 to provide an air filtering function. The at least one of the side shells 113 is movably combined with the bottom shell 111 and the top shell 112. In this way, at least one of the plurality of side shells 113 can move relative to the bottom shell 111 and the top shell 112, so as to cover or expose the at least one filtering mask 2, such that the at least one filtering mask 2 can be installed inside the casing 1 or removed from the casing 1.

Optionally, in one embodiment, as shown in FIGS. 1 and 2, the bottom shell 111 can be provided with the air inlet portion 1a. For example, the air inlet portion 1a has a plurality of first groups of through holes 11a, e.g., the plurality of first groups of through holes 11a are formed by a plurality of strip-shaped or circular through holes. The plurality of first groups of through holes 11a can be circumferentially arranged on the bottom shell 111, e.g., four first groups of through holes 11a are provided on the four lateral walls of the bottom shell 111 to inhale air from different directions. In one example, the bottom shell 111 includes a bottom substrate 111a and a first partition 111b, wherein the bottom substrate 111a is provided with the plurality of first groups of through holes 11a, and the first partition 111b is located between the bottom substrate 111a and the circulation assembly 12. It is not limited to the description here; in other implementations, the air inlet portion 1a can also be provided on other components, such as the top shell 112 or the side shells 113.

Optionally, in one embodiment, as shown in FIGS. 1 and 2, the top shell 112 can be provided with the air outlet portion 1b. The air outlet portion 1b has a plurality of second groups of through holes 11b, e.g., the plurality of second groups of through holes 11b are formed by a plurality of strip-shaped or circular through holes. The plurality of second groups of through holes 11b can be arranged on the top shell 112 in a coplanar manner, e.g., four second groups of through holes 11b are provided on a top surface of the top shell 112 to blow air in the same direction. In one example, the top shell 112 includes a top substrate 112a and a second partition 112b, and the top substrate 112a is provided with the plurality of second groups of through holes 11b, and the second partition 112b is located between the top substrate 112a and the fan 3. It is not limited to the description here; in other implementations, the air outlet portion 1b can also be provided on other components, such as the bottom shell 111 or the side shells 113.

Optionally, in one embodiment, as shown in FIGS. 1 and 2, the top shell 112 can also be defined with a recess portion 1121, wherein the recess portion 1121 is formed into a trough (such as a circular trough or a square trough). For example, the recess portion 1121 can be used to accommodate external objects. In addition, an inner circumferential wall of the recess portion 1121 can also be provided with a strip-shaped through hole 1122, such as a strip-shaped through hole 1122 that extends laterally. The strip-shaped through hole 1122 can be used as a hidden handle, such that a user can reach into the strip-shaped through hole 1122 with bare hands to lift the air purification device with the filtering mask.

Optionally, in one embodiment, as shown in FIGS. 1 and 2, only two types of side shells are taken as an example but are not limited to the description here. There may be a configuration composed of a single side shell or more types of side shells. For example, the plurality of side shells 113 include a first side shell 113a and at least one second side shell 113b, wherein the first side shell 113a is securely combined between the bottom shell 111 and the top shell 112, and the at least one second side shell 113b is movably combined between the bottom shell 111 and the top shell 112. Two second side shells 113b are taken as an example, e.g., the two second side shells 113b are located on two sides of the first side shell 113a. It is not limited to the description here; in other implementations, the number and positions of the plurality of side shells 113 can be fine-tuned according to the requirements of the actual application.

Optionally, in one embodiment, as shown in FIGS. 1 and 2, the first side shell 113a can be provided with a grip portion 114. For example, the grip portion 114 can be formed into a groove that can be used for people to hold the grip portion 114 to move the air purification device. It is not limited to the description here; in other implementations, the grip portion can also be formed into other structures convenient for gripping, e.g., the grip portion 114 can also be formed into a handle.

Optionally, in one embodiment, as shown in FIGS. 1 and 2, the at least one second side shell 113b is pivotably combined between the bottom shell 111 and the top shell 112. For example, two opposite sides of the second side shell 113b are provided with two first pivotal portions (such as slots) 1d, the bottom shell 111 is provided with a second pivotal part (such as a pin) 1e, and the top shell 112 is provided with a third pivotal part (such as a pin) lf. The second pivotal part 1e and the third pivotal part If are pivotably connected to the two first pivotal portions 1d, such that the second side shell 113b can pivot back and forth, such as horizontally pivoting to cover or expose the at least one filtering mask 2. It is not limited to the description here; in other implementations, at least one pivotal member, such as a hinge, can be provided between the at least one second side shell 113b and the first side shell 113a. Alternatively, the at least one second side shell 113b can be slidably or retractably combined between the bottom shell 111 and the top shell 112, so as to cover or expose the at least one filtering mask 2.

Optionally, in one embodiment, as shown in FIGS. 1 and 2, each of the second side shells 113b can also be provided with a side-opening portion 115, such that a person can open the second side shell 113b by hand. For example, the side-opening portion 115 can be formed into an edge-notch (such as forming an arc-shaped, polygonal, or jagged edge-notch portion) to provide an aesthetic effect. For example, the side-opening portion 115 can be symmetrically or correspondingly arranged on each of the second side shells 113b. It is not limited to the description here; in other implementations, the side-opening portion 115 can also be formed into other structures that are convenient for opening the second side shell 113b, e.g., the side-opening portion 115 can be formed into a through hole or can be provided with a pull ring.

Optionally, in one embodiment, as shown in FIGS. 1 and 2, the circulation assembly 12 includes a first circulation part 121 and a second circulation part 122, wherein the first circulation part 121 and the second circulation part 122 are coupled in fluid communication to form the air-guiding portion 1c. For example, the at least one filtering mask 2 is coupled in fluid communication between the first circulation part 121 and the air inlet portion 1a to provide an air filtering function.

Optionally, in one embodiment, as shown in FIGS. 1 and 2, the first circulation part 121 is defined with at least one first ventilation portion 12a and at least one second ventilation portion 12b; the second circulation part 122 is defined with at least one third ventilation portion 12c and at least one fourth ventilation portion 12d; the at least one filtering mask 2 is coupled in fluid communication between the at least one first ventilation portion 12a and the air inlet portion 1a, the at least one second ventilation portion 12b is coupled in fluid communication with the at least one third ventilation portion 12c, and the at least one fourth ventilation portion 12d is coupled in fluid communication with the air outlet portion 1b. In one example, the fan 3 is coupled in fluid communication between the at least one fourth ventilation portion 12d and the air outlet portion 1b, but is not limited to the description here. In this way, the air between the air inlet portion and the air outlet portion can be guided to pass through the at least one filtering mask for purification.

Optionally, in one embodiment, as shown in FIGS. 1 and 2, the second circulation part 122 may have at least one conduit 12e. In the present embodiment, only two conduits are taken as an example but are not limited to the description here. For example, each conduit 12e is coupled in fluid communication with the third ventilation portion 12c and the fourth ventilation portion 12d. In this way, it is convenient to guide the air filtered by the filtering mask to the air outlet portion.

Optionally, in one embodiment, as shown in FIGS. 1 and 2, the first circulation part 121 may be provided with at least one accommodating recess 12f, wherein the at least one accommodating recess 12f may be defined with at least one convex portion 12g (such as two sliding positioning bumps located on opposite sides, wherein only the convex portion 12g on the left side is shown in the figure). Correspondingly, the at least one filtering mask 2 is defined with at least one groove portion 2a (such as two sliding positioning grooves located on opposite sides, wherein only the groove portion 2a on the right side is shown in the figure). The groove portion 2a and the convex portion 12g are configured to be slidably engaged. For example, the groove portion 2a and the convex portion 12g are configured to be aligned on the same side, such that the at least one filtering mask 2 is detachably disposed in the at least one accommodating recess 12f. In this way, it is convenient for a person to push and pull the at least one filtering mask 2 to assemble and disassemble with bare hands.

In addition, as shown in FIGS. 1 and 2, the filtering mask 2 can be made of filter materials and plastics. It is worth noting that the filtering mask 2 is equipped with two filtration members, wherein one of the two filtration members is mainly used to purify the air in an indoor environment, and the other is mainly used to purify the air in a smoky environment. It can continuously provide the air purification function for the indoor environment and the air purification function for the smoky environment during use.

Optionally, in one embodiment, as shown in FIGS. 1 and 2, the filtering mask 2 has a first filtration member 21 and a second filtration member 22. It should be understood that the first filtration member 21 and the second filtration member 22 can be provided with a suitable form of air circulation structure (such as through holes and conduits) for air inflow and outflow to perform an air filtration process. For example, a first filtration member 21a, such as a high-efficiency particulate air (HEPA) medium, is disposed inside the first filtration member 21; a second filtration member 22a, such as a filter for anti-virus or poison filtering, is disposed inside the second filtration member 22. It is not limited to the description here; in an implementation, the second filtration member 22 is movably combined with the first filtration member 21, e.g., a movable combination structure such as a sleeve or a guide rail is adopted, such that the first filtration member 21 and the second filtration member 22 are movably combined in a reciprocating manner along an axial direction. As an example, the configuration and usage of the first filtration member 21 and the second filtration member 22 are illustrated as follows.

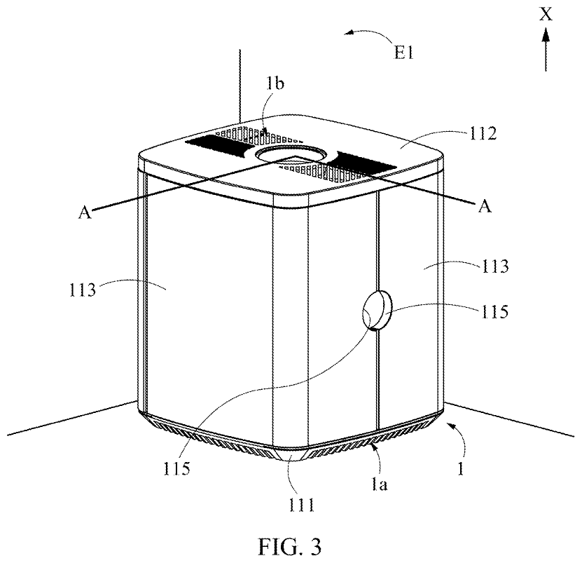

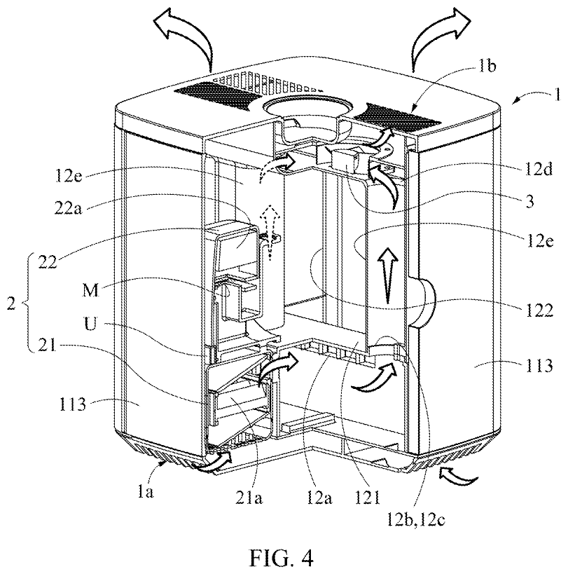

In an aspect, as shown in FIGS. 3 and 4, in an indoor environment E1, a first configuration mode can be adopted; the air inlet portion 1a, the first filtration member 21, and the air-guiding portion 1c are in a fluid-communication state (e.g., a first fluid-communication state). For example, by using the fan 3 to assist in generating airflow, the outside air from the air inlet portion 1a can flow into the first filtration member 21 to filter impurities (such as particles) in the air. The air flowing out of the first filtration member 21 can flow into the first ventilation portion 12a of the first circulation part 121. Then, the air can be guided to the air outlet portion 1b through the second ventilation portion 12b of the first circulation part 121, the third ventilation portion 12c of the second circulation part 122, and the fourth ventilation portion 12d of the second circulation part 122. The purified air can be discharged from the air outlet portion 1b, such that the air in an environment can be circulated and filtered to facilitate the purification of ambient air. Meanwhile, the second filtration member 22 is in a fluid-closed state. For example, the second filtration member 22 can be configured by coating a film or pasting a sealing film, causing the second filtration member 22a not to be used for filtering air. For example, at least one sealing membrane (such as two sealing membranes) M is used to close the channel's entrance communicating between the second filtration member 22 and other components (such as the first filtration member 21), such that the air from the first filtration member 21 will not flow into the second filtration member 22.

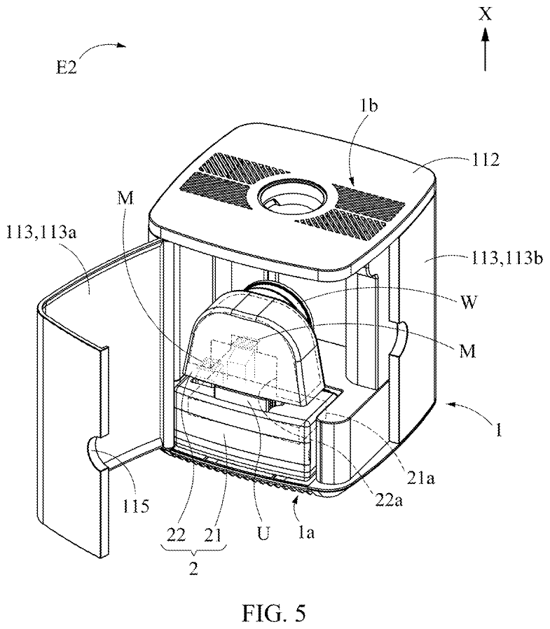

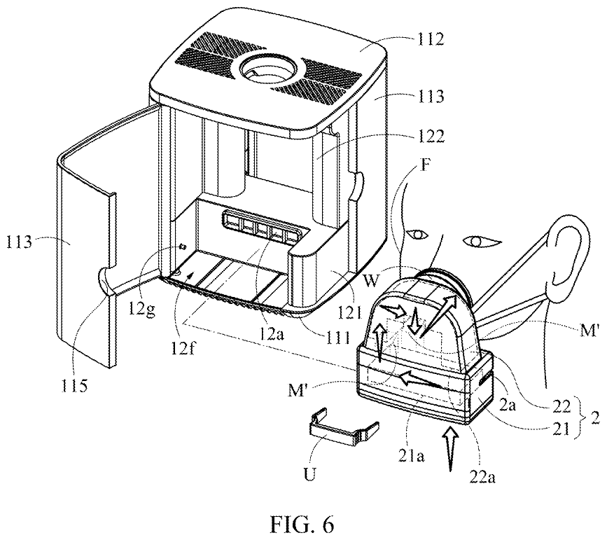

In another aspect, as shown in FIGS. 5 and 6, in a smoky environment E2, such as smog being produced in the indoor environment where the air purification device is located, a second configuration mode can be adopted. The first filtration member 21 and the casing 1 are in a mutually separated state. For example, the filtering mask 2 is taken out from the inside of the casing 1, such that the filtering mask 2 can be worn on a human face F. For example, the filtering mask 2 can be provided with a face-wearing accessory W that is used for users to wear the filtering mask 2 to inhale filtered air. It should be noted that the first filtration member 21 and the second filtration member 22 are in a fluid-communication state (e.g., a second fluid-communication state). For example, the first filtration member 21 and the second filtration member 22 are close to each other, such that at least one sealing membrane M between the first filtration member 21 and the second filtration member 22 can be physically damaged (such as being pierced to produce a hole), such that the at least sealing membrane M is formed into at least one broken membrane M′, causing that the air from the first filtration member 21 can flow into the second filtration member 22, to facilitate air to pass through the two-stage filtration between the first filtration member 21 and the second filtration member 22. For example, the first filtration member 21a and the second filtration member 22a can be used to filter the air for people to breathe, to be used in the fire and smoke prevention process to prevent people from inhaling toxic gases causing casualties.

Optionally, in an embodiment, as shown in FIGS. 1, 2, 5, and 6, the filtering mask 2 may also include a supporting member U, which is detachably provided between the first filtration member 21 and the second filtration member 22. For example, in the first configuration mode, the first filtration member 21 and the second filtration member 22 are configured to be held apart from each other by sandwiching the supporting member U to assist the second filtration member 22 in maintaining a fluid-closed state; in the second configuration mode, the supporting member U can be manually removed by a person, such that the second filtration member 22 can move toward the first filtration member 21, and the first filtration member 21 and the second filtration member 22 are in a fluid-communication state. In this way, after a user wears the filtering mask, the supporting member can be easily removed by hand, causing the second filtration member to be moved toward the first filtration member, making the first filtration member and the second filtration member in a fluid-communication state, which is beneficial to use the filtering mask to carry out the fire and smoke prevention process in an emergency case. It is not limited to the description here; a supporting structure between the first filtration member and the second filtration member can also be appropriately modified to form at least one part of the casing; an example is provided as follows.

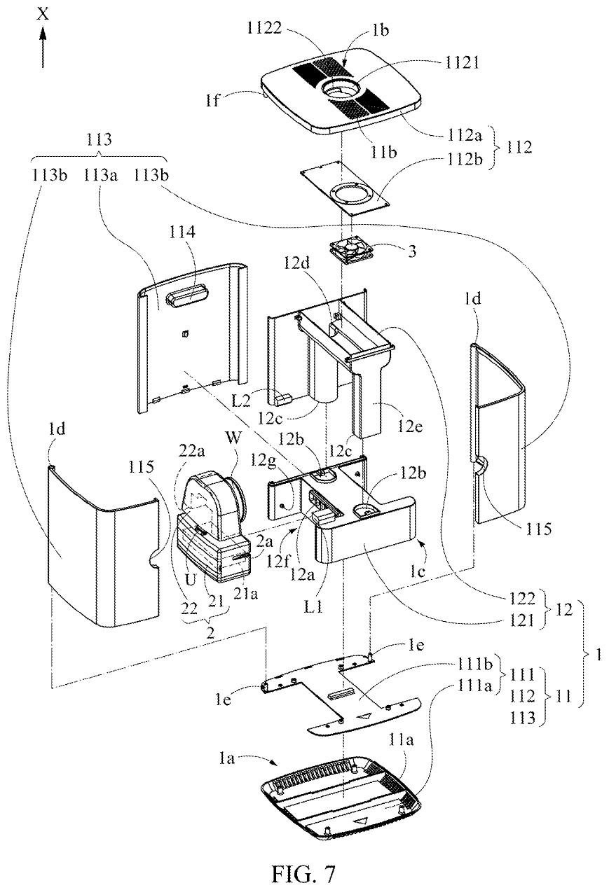

Alternatively, in one embodiment, as shown in FIG. 7, the first circulation part 121 of the circulation assembly 12 is provided with a first supporting portion L1, and/or the second circulation part 122 of the circulation assembly 12 is provided with a second supporting portion L2. In the first configuration mode, when the filtering mask 2 is installed in the space defined by the casing 1 (for example, the filtering mask 2 is slidably combined with the accommodating recess 12f), the first supporting portion L1 and/or the second supporting portion L2 can gradually slide in a space between the first filtration member 21 and the second filtration member 22 of the filtering mask 2, such that the first filtration member 21 and the second filtration member 22 is configured to be held apart from each other by sandwiching the first supporting portion L1 and/or the second supporting portion L2 to assist the second filtration member 22 for maintaining a fluid-tight state. In the second configuration mode, due to the first supporting portion L1 of the first circulation part 121 and/or the second supporting portion L2 of the second circulation part 122 remaining still, when the filtering mask 2 is taken out from the casing 1, the first supporting portion L1 and/or the second supporting portion L2 gradually slides out from the space between the first filtration member 21 and the second filtration member 22 until the first filtration member 21 and the second filtration member 22 are no longer held apart from each other by sandwiching the first supporting portion L1 and/or the second supporting portion L2, such that the second filtration member 22 can be driven by an external force (such as gravity) to move toward the first filtration member 21, causing the first filtration member 21 and the second filtration member 22 in a fluid-communication state. In this way, when a user takes out the filtering mask from the casing, a supporting structure between the first filtration member and the second filtration member can be automatically removed, such that the second filtration member directly moves toward the first filtration member, causing the first filtration member and the second filtration member gradually become the fluid-communication state. Thus, the user can omit manually removing a supporting member, which is beneficial to use the filtering mask to quickly carry out the fire and smoke prevention process in an emergency case.

In the air purification device of the above embodiments of the present disclosure, the at least one filtering mask is detachably arranged in the space defined by the casing, wherein the filtering mask has the first filtration member and the second filtration member movably combined with the first filtration member; in the first configuration mode, the air inlet portion, the first filtration member, and the air-guiding portion are configured to be in the first fluid-communication state, and the second filtration member is configured to be in the fluid-closed state; in a second configuration mode, the first filtration member and the casing are configured to be in the mutually separated state, and the first filtration member and the second filtration member are configured to be in the second fluid-communication state. It makes the air purification device integrate the function of the filtering mask in case of need.

Although the present disclosure has been disclosed in preferred embodiments, which are not intended to limit the disclosure, those skilled in the art can make various changes and modifications without departing from the spirit and scope of the disclosure. Therefore, the scope of protection of the present disclosure is defined as definitions of the scope of the claims.

What is claimed is:

1. An air purification device, comprising:
a casing provided with an air inlet portion, an air outlet portion, and an air-guiding portion, wherein the air-guiding portion is coupled in fluid communication between the air inlet portion and the air outlet portion;
at least one filtering mask detachably arranged in a space defined by the casing, wherein the filtering mask has a first filtration member and a second filtration member movably combined with the first filtration member; in a first configuration mode, the air inlet portion, the first filtration member, and the air-guiding portion are configured to be in a first fluid-communication state, and the second filtration member is configured to be in a fluid-closed state; in a second configuration mode, the first filtration member and the casing are configured to be in a mutually separated state, and the first filtration member and the second filtration member are configured to be in a second fluid-communication state; and
a fan disposed in the casing.

2. The air purification device as claimed in claim 1, wherein the casing has a shell assembly and a circulation assembly, the shell assembly surrounds the circulation assembly, and the at least one filtering mask is coupled in fluid communication between the shell assembly and the circulation assembly.

3. The air purification device as claimed in claim 2, wherein the circulation assembly comprises a first circulation part and a second circulation part, the first circulation part is coupled in fluid communication with the second circulation part to form the air-guiding portion, and the at least one filtering mask is coupled in fluid communication between the first circulation part and the air inlet portion.

4. The air purification device as claimed in claim 3, wherein the first circulation part is provided with a first supporting portion, and in the first configuration mode, the first filtration member and the second filtration member are configured to be held apart from each other by sandwiching the first supporting portion.

5. The air purification device as claimed in claim 3, wherein the second circulation part is provided with a second supporting portion, and in the first configuration mode, the first filtration member and the second filtration member are configured to be held apart from each other by sandwiching the second supporting portion.

6. The air purification device as claimed in claim 1, wherein the filtering mask is provided with a supporting member detachably disposed between the first filtration member and the second filtration member, and in the first configuration mode, the first filtration member and the second filtration member are configured to be held apart from each other by sandwiching the supporting member.

7. The air purification device as claimed in claim 3, wherein the first circulation part is defined with at least one first ventilation portion and at least one second ventilation portion, the second circulation part is defined with at least one third ventilation portion and at least one fourth ventilation portion, the at least one filtering mask is coupled in fluid communication between the at least one first ventilation portion and the air inlet portion, the at least one second ventilation portion is coupled in fluid communication with the at least one third ventilation portion, and the at least one fourth ventilation portion is coupled in fluid communication with the air outlet portion.

8. The air purification device as claimed in claim 7, wherein the second circulation part has at least one conduit, and the conduit is coupled in fluid communication with the third ventilation portion and the fourth ventilation portion.

9. The air purification device as claimed in claim 3, wherein the first circulation part is defined with at least one accommodating recess, the at least one accommodating recess is provided with at least one convex part, and the at least one filtering mask is defined with at least one groove that is configured to be slidably engaged with the convex part to cause the at least one filtering mask to be detachably disposed in the at least one accommodating recess.

10. The air purification device as claimed in claim 2, wherein the shell assembly comprises a bottom shell, a top shell, and a plurality of side shells, and the plurality of side shells are combined between the bottom shell and the top shell, the at least one filtering mask is disposed between the plurality of side shells and the circulation assembly, and at least one of the plurality of side shells is movably combined with the bottom shell and the top shell.

11. The air purification device as claimed in claim 10, wherein the plurality of side shells comprise a first side shell and at least one second side shell, the first side shell is securely combined with the bottom shell between the bottom shell and the top shell, and the at least one second side shell is movably combined between the bottom shell and the top shell.

12. The air purification device as claimed in claim 11, wherein the at least one second side shell is pivotably combined between the bottom shell and the top shell to cover or expose the at least one filtering mask.

13. The air purification device as claimed in claim 11, wherein the first side shell is provided with a holding portion that is formed into a slot.

14. The air purification device as claimed in claim 11, wherein the second side shell is provided with a side-opening portion that is formed into an edge-notch.

15. The air purification device as claimed in claim 10, wherein the air inlet portion has a plurality of first groups of through holes circumferentially disposed on the bottom shell.

16. The air purification device as claimed in claim 10, wherein the air outlet portion has a plurality of second groups of through holes disposed on the top shell in a coplanar manner.

17. The air purification device as claimed in claim 10, wherein the top shell is defined with a recess portion, and an inner peripheral wall of the recess portion has a strip-shaped through hole.

18. The air purification device as claimed in claim 1, wherein the first filtration member and the second filtration member are movably combined in a reciprocating manner along an axial direction.
